(19) United States
(12) Patent Application Publication
(10) Pub. No.: US 2026/0170814 A1
(43) Pub. Date: Jun. 18, 2026

(54) SKELETON SEQUENCE RECOGNITION METHOD AND SYSTEM BASED ON MASKED GRAPH AUTOENCODER

(71) Applicant: SUN YAT-SEN UNIVERSITY, Guangdong (CN)

(72) Inventors: Yang LIU, Guangdong (CN); Hong YAN, Guangdong (CN); Guanbin LI, Guangdong (CN); Qing WANG, Guangdong (CN); Liang LIN, Guangdong (CN)

(73) Assignee: SUN YAT-SEN UNIVERSITY, Guangdong (CN)

(21) Appl. No.: 18/715,746

(22) PCT Filed: Oct. 25, 2023
(86) PCT No.: PCT/CN2023/126489

§ 371 Date: Jun. 3, 2024

(30) Foreign Application Priority Data
Jun. 12, 2023 (CN) 202310688179.3

(51) Int. Cl. G06V 10/82

(52) U.S. Cl. CPC G06V 10/82

(57) ABSTRACT

The present invention discloses a skeleton sequence recognition method based on a masked graph autoencoder, including the following steps: building a skeleton action recognition model, using the skeleton action recognition model to recognize a skeleton sequence, and implementing prediction of an action category, where said skeleton action recognition model includes a spatio-temporal representation learning model at a M layer and a classifier at one layer; and said spatio-temporal representation learning model includes two masked graph autoencoders connected in parallel, and an output end of the masked graph autoencoder is residually connected to an input end thereof through 1×1 convolution.

### TECHNICAL FIELD

The present invention relates to the technical field of video action representation learning, and in particular, to a skeleton sequence recognition method and system based on a masked graph autoencoder.

### RELATED ART

Human action recognition has attracted increasing attention in video understanding because of wide application of the human action recognition in human-computer interaction, intelligent monitoring security, virtual reality, and the like. In terms of visual perception, a person can recognize an action category just by observing movement of a joint even without appearance information. Different from an RGB video, a skeleton sequence includes only coordinate information of key joints of a human body, and is high-level, lightweight, and robust to complex backgrounds and various conditions (including a viewpoint, scale and movement speed). In addition, with the development of a human posture estimation algorithm, a method for positioning a human joint (that is, a key point) has made great progress, and it is feasible to obtain an accurate skeleton sequence. Due to the huge potential and rapid development of a capability for modeling fine grain and large change of a human motion, the skeleton sequence is more proper than RGB data for distinguishing similar actions with a subtle difference. To capture a discriminative spatio-temporal motion pattern, existing skeleton-based action recognition methods are fully supervised and usually require a large amount of labeled data to train a well-designed model, which is time-consuming and laborious. To alleviate a problem of limited labeled training data, a self-supervised skeleton action recognition method has attracted increasing attention recently. Some contrastive learning methods generate positive and negative sample pairs by using data augmentation, but rely heavily on a quantity of contrastive pairs. With the popularity of an encoder-decoder, some methods follow a graph encoder-decoder normal form to encourage topological proximity by linking a reconstructed masked skeleton sequence. However, these methods usually achieve good performance in link prediction and node clustering, but not good performance in node and graph classification.

For accurate action recognition, fine-grained dependency (that is, graph classification) between different skeleton joints are crucial. However, a previous method based on self-supervised learning often ignores the fine-grained dependency between different skeleton joints, which limits the universality of a self-supervised skeleton representation.

### SUMMARY

To resolve a problem that the foregoing existing technology ignores fine-grained dependency between different skeleton joints, which limits versatility of a self-supervised skeleton representation, the present invention provides a skeleton sequence recognition method and system based on a masked graph autoencoder.

To achieve the foregoing purpose of the present invention, the following technical solutions are used:

A skeleton sequence recognition method based on a masked graph autoencoder is provided, and the method includes the following steps:
building a skeleton action recognition model, using the skeleton action recognition model to recognize a skeleton sequence, and implementing prediction of an action category;
where said skeleton action recognition model includes a spatio-temporal representation learning model at a M layer and a classifier at one layer; and
said spatio-temporal representation learning model includes two masked graph autoencoders connected in parallel, and an output end of the masked graph autoencoder is residually connected to an input end of the masked graph autoencoder through 1×1 convolution.

Preferably, said masked graph autoencoder includes one encoder G_{E} and one decoder G_{D}, where the encoder G_{E} includes a three-layer GIN, and the decoder G_{D} includes an one-layer GIN.

Preferably, a graph structure [symbol] related to the skeleton joint and a topological structure of the skeleton joint is established, and the topological structure of the skeleton joint and a skeleton joint feature are fused, to obtain a skeleton sequence matrix S∈R^{N×T×2}, where N represents a quantity of the skeleton joints, and T represents a quantity of the skeleton sequences; the skeleton sequence matrix S is converted into S∈R^{N×T×D} with a learnable parameter, where D represents dimension raising on an original skeleton sequence matrix S; and
for each skeleton joint feature matrix X∈R^{N×D}, the graph structure [symbol] =( [symbol] , A, X) represents a skeleton, where [symbol] ={v₁, v₂, . . . , v_{N}} is a node set including all skeleton joints; A∈{0,1}^{N×N} is an adjacent matrix, and if i and j are physically connected, A_{i,j}=1, otherwise, A_{i,j}=0; and a skeleton joint feature of a node vᵢ is expressed as xᵢ∈R^{1×D}, where i=1, . . . , N.

Further, a masked skeleton joint feature is used to train the masked graph autoencoder for reconstructing the skeleton sequence, and specifically, said masked graph autoencoder performs reconstruction training on the masked skeleton joint feature based on an established skeleton joint masking strategy and a re-weighted loss function.

Still further, establishing the skeleton joint masking strategy is specifically as follows:

[symbol] ={v₁, v₂, . . . , v_{N}} is divided according to body parts, each part is corresponding to one first joint subset, one or more first joint subsets are randomly selected, and the one or more first joint subsets form a second joint subset [symbol] ⊆ [symbol] for masking. Then, each skeleton joint feature of a human skeleton sequence is masked by using a learnable mask token vector [MASK]=x_{[M]}∈R^{D}. Therefore, the masked skeleton joint feature x̅ᵢ is defined in a masked joint feature matrix X̅ as follows: if vᵢ∈ [symbol] , x̅ᵢ=x_{[M]}, otherwise, x̅ᵢ=xᵢ;
the skeleton joint feature matrix X̅∈R^{N×D} is used as an input of the masked graph autoencoder, and each skeleton joint feature in the skeleton joint feature matrix X̅ is defined as x̅ᵢ={x_{[M]}, xᵢ}, i=1, 2, . . . , N; and
therefore, a masked skeleton is expressed as [symbol] =( [symbol] , A, X̅).

Still further, that said masked graph autoencoder reconstructs the masked skeleton joint feature is defined as follows:

$$\{ \begin{matrix}H = {G}_{E} ( A , \overline{X} ) , H ∈ {R}^{N \times {D}_{h}} \\ Y = {G}_{D} ( A , H ) , Y ∈ {R}^{N \times D}\end{matrix}$$

where H represents a middle layer feature matrix output by the encoder, and Y represents the skeleton joint feature matrix output by the decoder; and
said masked graph autoencoder is intended to minimize a difference between H and Y.

Still further, said re-weighted loss function represents an average value of a similarity difference between a reconstructed skeleton and an input original joint on all masked nodes, which is specifically as follows:
an original skeleton joint feature matrix X∈R^{N×D} and a reconstructed skeleton joint feature Y∈R^{N×D} output by the decoder are given, and the re-weighted loss function is defined as:

$${ℒ}_{R C E} = \frac{1}{\vert \overline{𝒱} \vert} {\sum }_{{v}_{i} ∈ \overline{𝒱}} {( 1 - \frac{{x}_{i}^{T} \cdot {z}_{i}}{‖ {x}_{i} ‖ \times ‖ {z}_{i} ‖} )}^{β}$$

in the formula, xᵢ represents an original skeleton joint feature, contained in X∈R^{N×D}; zᵢ represents a reconstructed skeleton joint feature, contained in Y∈R^{N×D}, and β represents a scaling factor.

Still further, said skeleton action recognition model recognizes the skeleton sequence and implements prediction of the action category, which is specifically as follows: the input skeleton sequence matrix S∈R^{N×T×D} is first added to a learnable time position embedding PE, to obtain a skeleton sequence feature matrix

$${H}_{t}^{( l )} ∈ {R}^{P \times N \times {D}^{( l )}} ;$$

separate features

$${H}_{t , 0}^{( l )} ∈ {R}^{N \times {D}^{( l )}} and {H}_{t , 1}^{( l )} ∈ {R}^{N \times {D}^{( l )}}$$

of two persons are obtained from

$${H}_{t}^{( l )} ;$$

and
a node representation

$${H}_{t , 0}^{( l )}$$

and prior knowledge Ã of a node are fed into a masked graph autoencoder,

$$SM ( {H}_{t , 0}^{( l )} ) = Repeat ( SP ( {G}_{E} ( \tilde{A} , {H}_{t , 0}^{( l )} ) ) ; N ) ⊕ {H}_{t , 0}^{( l )}$$

where G_{E} is the masked graph autoencoder; SP(⋅) represents sum pooling; Repeat (⋅; N) represents that after summation, a single node is repeated into N node representations, and is then residually connected to

$${H}_{t , 0}^{( l )} ,$$

to obtain a global node representation

$$SM ( {H}_{t , 0}^{( l )} ) ,$$

the masked graph autoencoder obtains global information through a single node representation, and some node features are constrained through all node representations; and similarly,

$$S M ( {H}_{t , 1}^{( l )} ) ,$$

is obtained;
the obtained node feature

$$S M ( {H}_{t}^{( l )} )$$

includes action interaction between a 0^{th} person and a 1^{st} person; according to an update rule for graph convolution,

$${H}_{t}^{( l + 1 )}$$

is obtained from

$${H}_{t}^{( l )}$$

in a multi-layer GCN, and a final skeleton sequence feature matrix representation is defined as follows:

$${H}_{t}^{( l + 1 )} = σ ( S M ( {H}_{t}^{( l )} ) {W}^{( l )} )$$

where W^{(l)} represents a trainable weight matrix of an l^{th} layer, and σ(⋅) represents a ReLU activation function;
then, a multi-scale spatio-temporal set is used to obtain the final skeleton sequence feature matrix; and
finally, the classifier predicts the action category based on a final skeleton sequence.

Preferably, before the skeleton action recognition model is used to recognize the skeleton sequence, a skeleton action recognition data set is input into the skeleton action recognition model, and a cross-entropy loss is used to fine-tune the skeleton action recognition model.

A computer system is provided, including a memory, a processor, and a computer program stored in the memory and runnable on the processor. When the processor executes the computer program, the steps of the foregoing method are implemented.

Beneficial effects of the present invention are as follows.

According to the present invention, the spatio-temporal representation learning model at the M layer and the classifier at one layer are used to build a skeleton action recognition model. The skeleton action recognition model uses fine-grained dependency between different skeleton joints for training learning, and is an efficient skeleton sequence learning model which can be generalized well on different data sets.

According to the present invention, the masked graph autoencoder based on skeleton masking is introduced for the skeleton action recognition model, and the masked graph autoencoder can perform unsupervised training.

The masked graph autoencoder constructed in the present invention embeds the skeleton joint sequence into a graph convolution network, and reconstructs a hidden skeleton joint and edge based on human body's prior topological knowledge. To reliably perform feature reconstruction, a re-weighted cosine error (RCE) is introduced.

### BRIEF DESCRIPTION OF DRAWINGS

FIG. 1 is a principle framework diagram of a skeleton action recognition model according to the present invention.

FIG. 2 is a principle framework diagram of a masked graph autoencoder according to the present invention.

FIG. 3 is a schematic training diagram of a masked graph autoencoder according to the present invention.

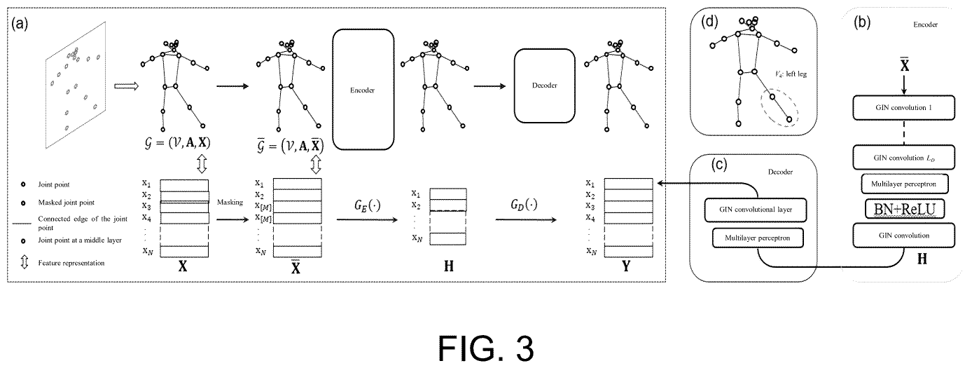

FIG. 4 is a schematic comparison diagram of masking of randomly selected nodes according to the present invention and the prior art.

### DESCRIPTION OF EMBODIMENTS

The present invention will be described in detail below with reference to the accompanying drawings and specific implementations.

### Embodiment 1

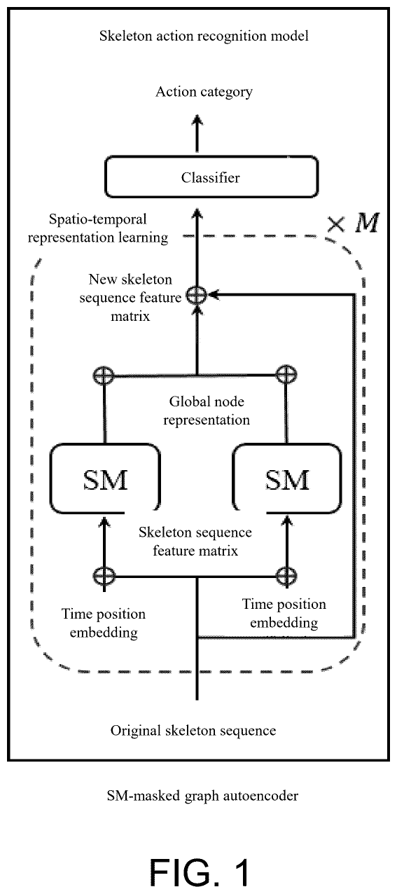

FIG. 1 shows a skeleton sequence recognition method based on a masked graph autoencoder. The method includes the following steps:
building a skeleton action recognition model, using the skeleton action recognition model to recognize a skeleton sequence, and implementing prediction of an action category, where
said skeleton action recognition model (SSL) includes a spatio-temporal representation learning model (STRL) at a M layer and a classifier at one layer; and
said spatio-temporal representation learning model (STRL) includes two masked graph autoencoders (SkeletonMAE, SM) connected in parallel, and an output end of the masked graph autoencoder (SkeletonMAE, SM) is residually connected to an input end of the masked graph autoencoder (SkeletonMAE) through 1×1 convolution.

According to the present invention, the spatio-temporal representation learning model (STRL) at the M layer and the classifier at one layer are used to build the skeleton action recognition model. The skeleton action recognition model uses fine-grained dependency between different skeleton joints for training learning, is an efficient skeleton sequence learning model, and can be generalized well on different data sets.

According to the present invention, the masked graph autoencoder based on skeleton masking is introduced for the skeleton action recognition model, and the masked graph autoencoder can perform unsupervised training.

In a specific embodiment, said masked graph autoencoder includes one encoder G_{E} and one decoder G_{D}. The encoder G_{E} includes a three-layer GIN and the decoder G_{D} includes one-layer GIN.

In a specific embodiment, N human skeleton joints and T skeleton sequences are preprocessed. A graph structure [symbol] related to the skeleton joint and a topological structure of the skeleton joint is established, and the topological structure of the skeleton joint and a skeleton joint feature are fused, to obtain a skeleton sequence matrix S∈R^{N×T×2}, where N represents a quantity of the skeleton joints, and T represents a quantity of the skeleton sequences. The skeleton sequence matrix S is converted into S∈R^{N×T×D} with a learnable parameter, where D represents dimension raising on an original skeleton sequence matrix S. In this embodiment, T and D are set to 64 based on experience.

For each skeleton joint feature matrix X∈R^{N×D}, the graph structure [symbol] =( [symbol] , A, X) represents a skeleton, where [symbol] ={v₁, v₂, . . . , v_{N}} is a node set including all skeleton joints; A∈{0,1}^{N×N} is an adjacent matrix, and if i and j are physically connected, A_{i,j}=1, otherwise, A_{i,j}=0; and a skeleton joint feature of a node vᵢ is expressed as xᵢ∈R^{1×D}, where i=1, . . . , N. In this embodiment, a quantity of the skeleton joints is N=17.

In a specific embodiment, a masked skeleton joint feature is used to train the masked graph autoencoder for reconstructing the skeleton sequence. Specifically, said masked graph autoencoder performs reconstruction training on the masked skeleton joint feature based on an established skeleton joint masking strategy and a re-weighted loss function.

Still further, establishing the skeleton joint masking strategy is specifically as follows:

To mask the skeleton joint feature, [symbol] ={v₁, v₂, . . . , v_{N}} is divided into six body parts: a head, four limbs, and a trunk, respectively corresponding to first joint subsets of V₀, . . . , V₅. One or more first joint subsets are randomly selected, the one or more first joint subsets form a second joint subset [symbol] ⊆ [symbol] , which is used for masking. For a human skeleton sequence, each joint communicates with some of neighboring joints to represent a specific action category. Therefore, it is not feasible to mask all joint sets for all action categories.

Then, each skeleton joint feature of a human skeleton sequence is masked by using a learnable mask token vector [MASK]=x_{[M]}∈R^{D}. Therefore, the masked skeleton joint feature x̅ᵢ is defined in a masked skeleton joint feature matrix X̅ as follows: if vᵢ∈ [symbol] , x̅ᵢ=x_{[M]}, otherwise, x̅ᵢ=xᵢ.

The skeleton joint feature matrix X̅∈R^{N×D} is used as an input of the masked graph autoencoder, and each joint feature in the skeleton joint feature matrix X̅ is defined as x̅ᵢ={x_{[M]}, xᵢ}, i=1, 2, . . . , N.

Therefore, a masked skeleton is expressed as [symbol] =(V, A, X̅).

Said masked graph autoencoder reconstructs the masked skeleton joint feature in the second joint subset [symbol] in a case that the masked skeleton joint feature matrix X̅ and an adjacent matrix A are given.

That said masked graph autoencoder reconstructs the masked skeleton joint feature is defined as follows:

$$\{ \begin{matrix}H = {G}_{E} ( A , \overline{X} ) , H ∈ {R}^{N \times {D}_{h}} \\ Y = {G}_{D} ( A , H ) , Y ∈ {R}^{N \times D}\end{matrix}$$

where H represents a middle layer feature matrix output by the encoder, and Y represents the skeleton joint feature matrix output by the decoder; and
the masked graph autoencoder is intended to minimize a difference between H and Y.

In a specific embodiment, in image and video tasks, a common reconstruction loss of the masked graph autoencoder is a mean square error (MSE). For the skeleton sequence, multidimensional and continuous nature of a node feature makes it difficult to perform reliable feature reconstruction on the mean square error, because the mean square error is sensitive to a dimension and vector normal form of the feature. Through l₂ normalization in a cosine error, a vector is mapped to an unit hypersphere, and stability of training is greatly improved. The cosine error is used as the basis of reconstruction.

To make a reconstruction standard tend to a relatively difficult sample between a simple sample and a difficult sample that are unbalanced, a re-weighted cosine error function (RCE) is introduced for the masked graph autoencoder. The re-weighted cosine error function is based on such a manner that a proportion of the simple sample in training can be reduced by scaling the cosine error by a power of β≥1. For prediction with high confidence, a corresponding cosine error is usually less than 1 and decays to zero faster when a scaling factor is β>1.

In this embodiment, said re-weighted loss function represents an average value of a similarity difference between a reconstructed skeleton joint feature and an input original skeleton joint feature on all masked nodes, which is specifically as follows:
an original skeleton joint feature matrix X∈R^{N×D} and a reconstructed skeleton joint feature matrix Y∈R^{N×D} output by the decoder are given, and the re-weighted loss function is defined as:

$${ℒ}_{R C E} = \frac{1}{\vert \overline{𝒱} \vert} {\sum }_{{v}_{i} ∈ \overline{𝒱}} {( 1 - \frac{{x}_{i}^{T} \cdot {z}_{i}}{‖ {x}_{i} ‖ \times ‖ {z}_{i} ‖} )}^{β}$$

In the formula, xᵢ represents an original key point feature, contained in X∈R^{N×D}; zᵢ represents a reconstructed key point feature, contained in Y∈R^{N×D}, and β represents the scaling factor.

The re-weighted loss function reduces a proportion of the simple sample in training by scaling the cosine error by a power of β≥1. For prediction with high confidence, a corresponding cosine error is usually less than 1 and decays to zero faster when a scaling factor is β>1.

In this embodiment, β is set to 2. The skeleton sequence is reconstructed by training the masked graph autoencoder, and a pre-trained masked graph autoencoder can fully perceive the human skeleton structure and obtain an action representation with judgment. After pre-training, said masked graph autoencoder can be embedded into the skeleton action recognition model for fine-tuning.

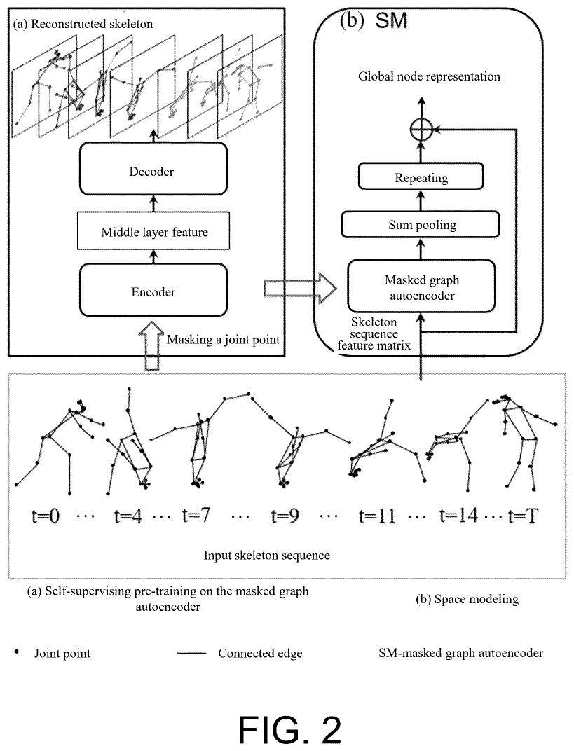

In a specific embodiment, to evaluate a generalization capability of the masked graph autoencoder for skeleton action recognition, a complete skeleton action recognition model is established, namely, a skeleton sequence learning framework (SSL), based on the pre-trained masked graph autoencoder. To capture multi-person interaction, two pre-trained masked graph autoencoders are integrated, to build a spatio-temporal representation learning (STRL) module, as shown in FIG. 2(b) and FIG. 2(c). The entire skeleton action recognition model includes an STRL model at a M layer and a classifier. Finally, a skeleton action recognition data set is input into the skeleton action recognition model, and a cross-entropy loss is used to perform fine-tuning on the skeleton action recognition model.

In this embodiment, said skeleton action recognition model recognizes the skeleton sequence, and implements prediction of the action category, which is specifically as follows: the input skeleton sequence matrix S∈R^{N×T×D} is first added to a learnable time position embedding PE, to obtain the skeleton sequence feature matrix

$${H}_{t}^{( l )} ∈ {R}^{P \times N \times {D}^{( l )}} .$$

Separate features

$${H}_{t , 0}^{( l )} ∈ {R}^{N \times {D}^{( l )}} and {H}_{t , 1}^{( l )} ∈ {R}^{N \times {D}^{( l )}}$$

of two persons (P=2) are obtained from

$${H}_{t}^{( l )} .$$

Here, a node feature of a 0^{th} person is used as an example, and an operation of a 1^{st} person is implemented similarly. A node representation

$${H}_{t , 0}^{( l )}$$

and prior knowledge Ã or a node are fed into a masked graph autoencoder,

$$SM ( {H}_{t , 0}^{( l )} ) = Repeat ( SP ( {G}_{E} ( \tilde{A} , {H}_{t , 0}^{( l )} ) ) ; N ) ⊕ {H}_{t , 0}^{( l )}$$

where G_{E} is the masked graph autoencoder; SP(⋅) represents sum pooling; Repeat (⋅; N) represents that after summation, a single node is repeated into N node representations, and is then residually connected to

$${H}_{t , 0}^{( l )} ,$$

to obtain a global node representation

$$S M ( {H}_{t , 0}^{( l )} ) .$$

The masked graph autoencoder obtains global information through a single node representation, and some node features are constrained through all node representations.

Similarly,

$$S M ( {H}_{t , 1}^{( l )} )$$

is obtained in a same manner.

$$SM ( {H}_{t , 1}^{( l )} ) = Repeat ( SP ( {G}_{E} ( \tilde{A} , {H}_{t , 1}^{( l )} ) ) ; N ) ⊕ {H}_{t , 1}^{( l )} .$$

The obtained node feature

$$S M ( {H}_{t}^{( l )} )$$

includes action interaction between the 0^{th} person and the 1^{st} person. According to an update rule for graph convolution,

$${H}_{t}^{( l + 1 )}$$

is obtained from

$${H}_{t}^{( l )}$$

in a multi-layer GCN, and a final skeleton sequence feature matrix representation is defined as follows:

$${H}_{t}^{( l + 1 )} = σ ( SM ( {H}_{t}^{( l )} ) {W}^{( l )} )$$

where W^{(l)} represents a trainable weight matrix of an l^{th} layer, and σ(⋅) represents a ReLU activation function;
then, a multi-scale spatio-temporal set is used to obtain the final skeleton sequence feature matrix; and
finally, the classifier predicts the action category based on a final skeleton sequence.

In a specific embodiment, before the skeleton action recognition model is used to recognize the skeleton sequence, the skeleton action recognition data set is input into the masked graph autoencoder for unsupervised pre-training, the masked graph autoencoder is then fine-tuned on the skeleton action recognition model, and the skeleton action recognition model recognizes an action by using the cross-entropy loss.

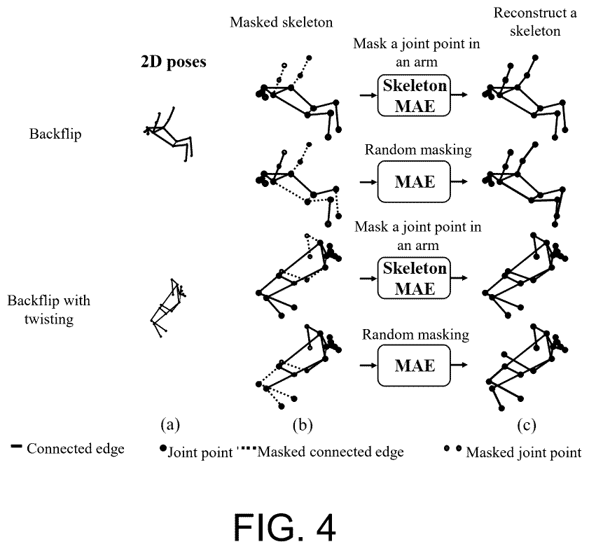

FIG. 4 shows a schematic comparison diagram of masking of randomly selected nodes according to the present invention and the prior art. First, the present invention is corresponding to a skeleton MAE, and the prior art is corresponding to an MAE. In FIG. 4, two fine-grained action labels are illustrated. An action in an upper figure is backflip, and an action in a lower figure is backflip with body twisting. Masking in the present invention is for body parts, because 17 key points, namely joint points, of a human body, are divided into six body parts, namely a head, four limbs, and a trunk. A masking strategy of the present invention is masking the parts. However, in an existing MAE, some key points are randomly selected from the 17 key points of the human body to be masked. According to the present invention, a part of the body can be unmasked selectively according to prior knowledge, so that the performance of the model is improved.

### Embodiment 2

This embodiment also provides a computer system, including a memory, a processor, and a computer program stored in the memory and runnable on the processor. When said processor executes said computer program, the steps of the method described in Embodiment 1 are implemented.

The memory and the processor are connected using a bus. The bus may include interconnected buses and bridges of any quantity. The bus connects various circuits of one or more processors and memories. The bus may further connect various other circuits together, such as a peripheral device, a voltage regulator, and a power management circuit, which are all well known in the art. Therefore, this specification provides no further description. A bus interface provides an interface between the bus and a transceiver. The transceiver may be one component or a plurality of components, for example, a plurality of receivers and transmitters, and provide a unit that is configured to communicate with various other apparatuses on a transmission medium. Data processed by the processor is transmitted on a wireless medium by using an antenna. Further, the antenna further receives data and transmits the data to the processor.

### Embodiment 3

A computer-readable storage medium stores a computer program. When said computer program is executed by a processor, the steps of the method described in Embodiment 1 are implemented.

To be specific, a person skilled in the art can understand that all or some of steps in the method of the foregoing embodiments can be completed by instructing relevant hardware through a program. The program is stored in a storage medium and includes several instructions to enable a device (which may be a single-chip microcontroller, a chip, or the like) or a processor (processor) to perform all or some of the steps of the method described in various embodiments of this application. The foregoing storage medium includes various media that can store program code, such as a USB flash drive, a mobile hard disk, a read-only memory (ROM, Read-Only Memory), a random access memory (RAM, Random Access Memory), a magnetic disk, or an optical disc.

Obviously, the foregoing embodiments of the present invention are only examples for clearly illustrating the present invention, and are not intended to limit the implementation of the present invention. Any modifications, equivalent substitutions, improvements, and the like made within the spirit and principle of the present invention should be included within the protection scope of the claims of the present invention.

1. A skeleton sequence recognition method based on a masked graph autoencoder, wherein the method comprises the following steps:
building a skeleton action recognition model, using the skeleton action recognition model to recognize a skeleton sequence, and implementing prediction of an action category;
said skeleton action recognition model comprises a spatio-temporal representation learning model at a M layer and a classifier at one layer; and
said spatio-temporal representation learning model comprises two masked graph autoencoders connected in parallel, and an output end of the masked graph autoencoder is residually connected to an input end of the masked graph autoencoder through 1×1 convolution.

2. The skeleton sequence recognition method based on the masked graph autoencoder according to claim 1, wherein said masked graph autoencoder comprises one encoder G_{E} and one decoder G_{D}, wherein the encoder G_{E} comprises a three-layer GIN and the decoder G_{D} comprises one-layer GIN.

3. The skeleton sequence recognition method based on the masked graph autoencoder according to claim 1, wherein a graph structure [symbol] related to a skeleton joint and a topological structure of the skeleton joint is established, and the topological structure of the skeleton joint and a skeleton joint feature are fused, to obtain a skeleton sequence matrix S∈R^{N×T×2}, wherein N represents a quantity of the skeleton joints, and T represents a quantity of the skeleton sequences; the skeleton sequence matrix S is converted into S∈R^{N×T×D} with a learnable parameter, wherein D represents dimension raising on an original skeleton sequence matrix S; and
for each skeleton joint feature matrix X∈R^{N×D}, the graph structure [symbol] =( [symbol] , A, X) represents a skeleton, wherein [symbol] ={ [symbol] ₁, [symbol] ₂, . . . , [symbol] } is a node set comprising all skeleton joints; A∈{0,1}^{N×N} is an adjacent matrix, and if i and j are physically connected, A_{i,j}=1, otherwise, A_{i,j}=0; and a skeleton joint feature of a node vᵢ is expressed as xᵢ∈R^{1×D}, wherein i=1, . . . , N.

4. The skeleton sequence recognition method based on the masked graph autoencoder according to claim 2, wherein a masked skeleton joint feature is used to train the masked graph autoencoder for reconstructing the skeleton sequence, and specifically, said masked graph autoencoder performs reconstruction training on the masked skeleton joint feature based on an established skeleton joint masking strategy and a re-weighted loss function.

5. The skeleton sequence recognition method based on the masked graph autoencoder according to claim 4, wherein establishing the skeleton joint masking strategy is specifically as follows: [symbol]
={ [symbol] , [symbol] , . . . , [symbol] } is divided according to body parts, each part is corresponding to one first joint subset, one or more first joint subsets are randomly selected, and the one or more first joint subsets form a second joint subset [symbol] ⊆ [symbol] ;
then, each skeleton joint feature of a human skeleton sequence is masked by using a learnable mask token vector [MASK]=x_{[M]}∈R^{D}; therefore, the masked skeleton joint feature x̅ᵢ is defined in a masked joint feature matrix X̅ as follows: if vᵢ∈ [symbol] , x̅ᵢ=x_{[M]}, otherwise, x̅ᵢ=xᵢ;
the skeleton joint feature matrix X̅∈R^{N×D} is used as an input of the masked graph autoencoder, and each skeleton joint feature in the skeleton joint feature matrix X̅ is defined as x̅ᵢ={x_{[M]}, xᵢ}, i=1, 2, . . . , N; and
therefore, a masked skeleton is expressed as [symbol] =( [symbol] , A, X̅).

6. The skeleton sequence recognition method based on the masked graph autoencoder according to claim 5, wherein that said masked graph autoencoder reconstructs the masked skeleton joint feature is defined as follows:
$$\{ \begin{matrix}H = {G}_{E} ( A , \overline{X} ) , H ∈ {R}^{N \times {D}_{h}} \\ Y = {G}_{D} ( A , H ) , Y ∈ {R}^{N \times D}\end{matrix}$$
wherein H represents a middle layer feature matrix output by the encoder, and Y represents the skeleton joint feature matrix output by the decoder; and
said masked graph autoencoder is intended to minimize a difference between H and Y.

7. The skeleton sequence recognition method based on the masked graph autoencoder according to claim 6, wherein said re-weighted loss function represents an average value of a similarity difference between a reconstructed skeleton joint feature and an input original skeleton joint feature on all masked nodes, which is specifically as follows:
an original skeleton joint feature matrix X∈R^{N×D} and a reconstructed skeleton joint feature matrix Y∈R^{N×D} output by the decoder are given, and the re-weighted loss function is defined as:
$${ℒ}_{RCE} = \frac{1}{\vert \overline{𝒱} \vert} {\sum }_{{v}_{i} ∈ \overline{𝒱}} {( 1 - \frac{{x}_{i}^{T} \cdot {z}_{i}}{‖ {x}_{i} ‖ \times ‖ {z}_{i} ‖} )}^{β}$$
in the formula, xᵢ represents an original skeleton joint feature, contained in X∈R^{N×D}; zᵢ represents a reconstructed skeleton joint feature, contained in Y∈R^{N×D}, and β represents a scaling factor.

8. The skeleton sequence recognition method based on the masked graph autoencoder according to claim 3, wherein said skeleton action recognition model recognizes the skeleton sequence and implements prediction of the action category, which is specifically as follows: the input skeleton sequence matrix S∈R^{N×T×D} is first added to a learnable time position embedding PE, to obtain a skeleton sequence feature matrix
$${H}_{t}^{( l )} ∈ {R}^{P \times N \times {D}^{( l )}} ;$$
separate features
$${H}_{t , 0}^{( l )} ∈ {R}^{N \times {D}^{( l )}} and {H}_{t , 1}^{( l )} ∈ {R}^{N \times {D}^{( l )}}$$
of two persons are obtained from
$${H}_{t}^{( l )} ;$$
and
a node representation
$${H}_{t , 0}^{( l )}$$
and prior knowledge Ã of a node are fed into a masked graph autoencoder,
$$SM ( {H}_{t , 0}^{( l )} ) = Repeat ( SP ( {G}_{E} ( \tilde{A} , {H}_{t , 0}^{( l )} ) ) ; N ) ⊕ {H}_{t , 0}^{( l )}$$
wherein G_{E} is the masked graph autoencoder; SP(⋅) represents sum pooling; Repeat (⋅; N) represents that after summation, a single node is repeated into N node representations, and is then residually connected to
$${H}_{t , 0}^{( l )} ,$$
to obtain a global node representation
$$SM ( {H}_{t , 0}^{( l )} ) ,$$
the masked graph autoencoder obtains global information through a single node representation, and some node features are constrained through all node representations; and similarly,
$$SM ( {H}_{t , 1}^{( l )} )$$
is obtained;
the obtained node feature
$$SM ( {H}_{t}^{( l )} )$$
comprises action interaction between a 0^{th} person and a 1^{st} person; and according to an update rule for graph convolution,
$${H}_{t}^{( l + 1 )}$$
is obtained from
$${H}_{t}^{( l )}$$
in a multi-layer GUN, and a final skeleton sequence feature matrix representation is defined as follows:
$${H}_{t}^{( l + 1 )} = σ ( SM ( {H}_{t}^{( l )} ) {W}^{( l )} )$$
wherein W^{(l)} represents a trainable weight matrix of an l^{th} layer, and σ(⋅) represents a ReLU activation function;
then, a multi-scale spatio-temporal set is used to obtain the final skeleton sequence feature matrix; and
finally, the classifier predicts the action category based on a final skeleton sequence.

9. The skeleton sequence recognition method based on the masked graph autoencoder according to claim 1, wherein before the skeleton action recognition model is used to recognize the skeleton sequence, a skeleton action recognition data set is input into the skeleton action recognition model, and a cross-entropy loss is used to fine-tune the skeleton action recognition model.

10. A computer system, comprising a memory, a processor, and a computer program stored in the memory and runnable on the processor, wherein when said processor executes said computer program, the steps of the method according to claim 1 are implemented.

11. A computer system, comprising a memory, a processor, and a computer program stored in the memory and runnable on the processor, wherein when said processor executes said computer program, the steps of the method according to claim 2 are implemented.

12. A computer system, comprising a memory, a processor, and a computer program stored in the memory and runnable on the processor, wherein when said processor executes said computer program, the steps of the method according to claim 3 are implemented.

13. A computer system, comprising a memory, a processor, and a computer program stored in the memory and runnable on the processor, wherein when said processor executes said computer program, the steps of the method according to claim 4 are implemented.

14. A computer system, comprising a memory, a processor, and a computer program stored in the memory and runnable on the processor, wherein when said processor executes said computer program, the steps of the method according to claim 5 are implemented.

15. A computer system, comprising a memory, a processor, and a computer program stored in the memory and runnable on the processor, wherein when said processor executes said computer program, the steps of the method according to claim 6 are implemented.

16. A computer system, comprising a memory, a processor, and a computer program stored in the memory and runnable on the processor, wherein when said processor executes said computer program, the steps of the method according to claim 7 are implemented.

17. A computer system, comprising a memory, a processor, and a computer program stored in the memory and runnable on the processor, wherein when said processor executes said computer program, the steps of the method according to claim 8 are implemented.

18. A computer system, comprising a memory, a processor, and a computer program stored in the memory and runnable on the processor, wherein when said processor executes said computer program, the steps of the method according to claim 9 are implemented.
